(19) United States
(12) Patent Application Publication
(10) Pub. No.: US 2015/0312193 A1
(43) Pub. Date: Oct. 29, 2015

(54) SYSTEMS AND METHODS FOR ACCUMULATING MESSAGES IN A MESSAGING CONVERSATION

(71) Applicant: ConversePoint LLC, Chicago, IL (US)

(72) Inventors: Randall G. Menna, Chicago, IL (US); Peter Kelso, Chicago, IL (US)

(73) Assignee: CONVERSEPOINT LLC, Chicago, IL (US)

(21) Appl. No.: 14/648,547

(22) PCT Filed: Nov. 29, 2013
(86) PCT No.: PCT/US2013/072505

§ 371 Date: May 29, 2015

Related U.S. Application Data
(60) Provisional application No. 61/732,209, filed on Nov. 30, 2012.

(51) Int. Cl. H04L 12/58; G06Q 30/08

(52) U.S. Cl. CPC H04L 51/18; G06Q 30/08

(57) ABSTRACT

Systems and methods are provided for facilitating an exchange in a messaging conversation between an originating entity and a plurality of recipient entities. According to certain aspects, a facilitating entity detects that an originating entity has sent a message to a plurality of recipient entities. The facilitating entity receives response messages from at least some of the recipient entities and accumulates the response messages into a single accumulated message, In some embodiments, die facilitating entity accumulates the response messages in response to a predefined criteria being met, Further, in accumulating the response message, the facilitating entity can initiate an application.

### CROSS-REFERENCE TO RELATED APPLICATION

This international application claims priority to U.S. Provisional Application No. 61/732209, filed Nov. 30, 2012, which is incorporated herein by reference in its entirety.

### FIELD

This application generally relates to managing messages to and from a plurality of entities in a messaging conversation. In particular, the application relates to platforms and techniques for consolidating or accumulating messages to reduce a total messaging volume.

### BACKGROUND

With the increasing prevalence of devices and technology offering messaging and general communication capabilities, individuals are able to more easily and frequently communicate with contacts and other individuals. For example, individuals can send emails, text messages, and other data communications to recipients. With the advancing growth of smart phones, there is an ongoing shift in communications from personal messages to group communication. Particularly, in personal messaging, one party communicates with another party and they engage in an exchange of information. In group communication, one party communicates with a group of individuals, also for the purpose of exchanging information.

However, deficiencies exist in current group communication technologies and protocols. In particular, simply mapping the techniques of personal messaging to a group does not scale in effectiveness and efficiency. For example, getting the right information to the right individuals, ensuring that the right individual is in the conversation, not overloading certain individuals with useless or irrelevant information, and modifying messages into a format or to contain information that can be readily interpreted or understood by the recipients are all challenges that are not addressed by current group communication technologies. Further, the nature of group messaging increases the volume of messages or communications that are sent among the participants of the group communication.

Accordingly, there is an opportunity to develop techniques for making group communication effective, efficient and reliable. In particular, there is an opportunity to develop techniques for reducing the amount of messages sent among participants of a group conversation. Further, there is an opportunity to develop techniques for consolidating or accumulating return messages associated with a previously-sent message into a single accumulated message.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed embodiments, and explain various principles and advantages of those embodiments.

FIG. 1 illustrates an existing data communication pattern in accordance with some embodiments.

FIG. 2 illustrates an exemplary data communication pattern in accordance with some embodiments.

FIG. 3 illustrates an exemplary application of the message facilitation techniques in accordance with some embodiments.

FIGS. 4A and 4B illustrate an exemplary application of the message facilitation techniques in accordance with some embodiments.

FIG. 5 illustrates an exemplary application of the message facilitation techniques in accordance with some embodiments.

FIG. 6 is a block diagram of a device in accordance with some embodiments.

FIG. 7 is a flow diagram depicting message facilitation in accordance with some embodiments.

### DETAILED DESCRIPTION

The present embodiments are defined by the appended claims. This description summarizes some aspects of the present embodiments and should not be used to limit the claims.

Systems and methods are disclosed for facilitating conversational or group messaging, wherein participant entities can exchange messages and message responses in one or more sets or rounds. Contrary to conventional messaging, the systems and methods as described herein describe a facilitating entity capable of receiving return messages associated with the conversation and accumulating the return messages into an accumulated message. Using the facilitating entity, the embodiments create conversation construction patterns that may encompass multiple rounds, and where the message facilitation can be directed according to logic, state, and instruction.

The systems and methods support control of message routing and distribution via intercepting messages, analyzing messages, and accumulating the messages before sending the messages to one of the entities of the conversation. Particularly, logic and other evaluative techniques can be used to analyze individual and collected messages, message data, and message metadata according to predefined criteria and other parameters. The systems and methods can advantageously make group messaging techniques more effective, efficient and reliable. For example, the facilitating entity, after receiving a plurality of messages, can generate a single message that indicates the content of the plurality of messages to reduce the amount of messages that are sent among the entities of the conversation. It should be appreciated that the entities as discussed herein can be a human, a system, a system acting on behalf of a human, a corporation, a company, an enterprise, or other types of entities.

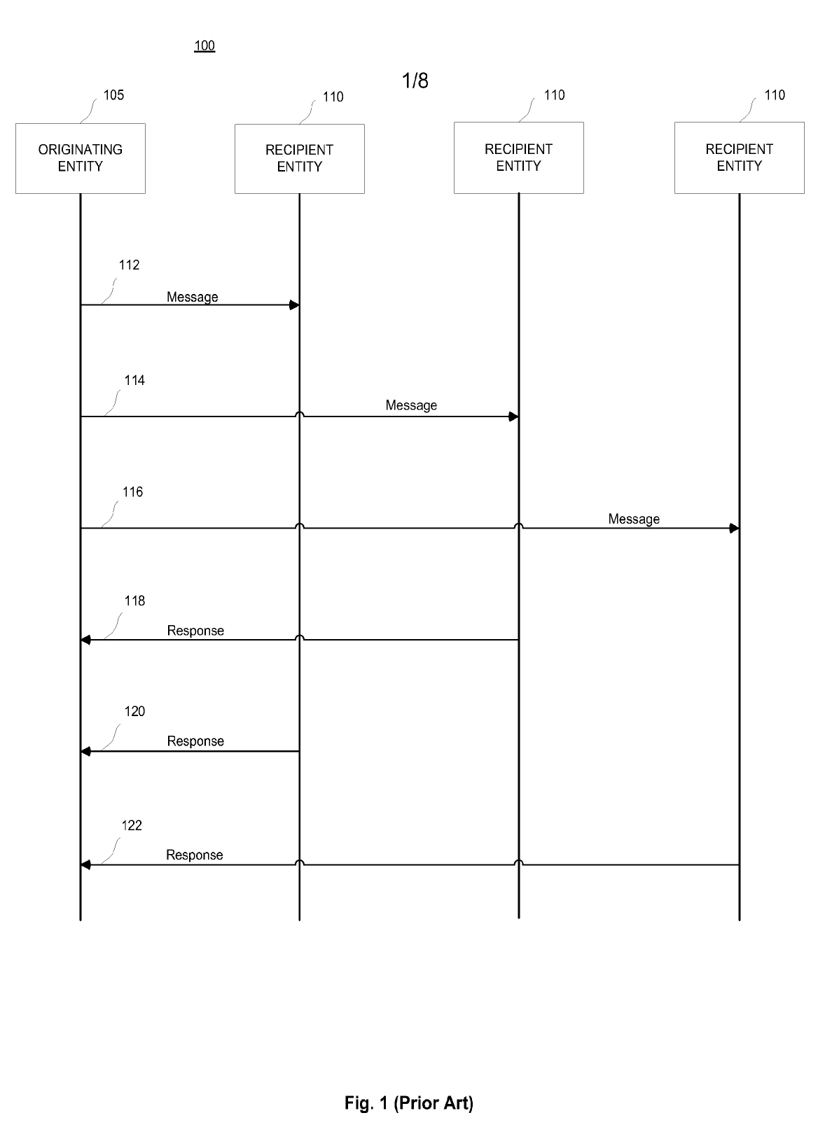

Referring to FIG. 1, depicted is a currently existing communication technology pattern 100 related to sending a message to a plurality of recipient entities. As shown in FIG. 1, the pattern 100 includes an originating entity 105 and three (3) recipient entities 110, wherein the originating entity 105 has a message that it intends to send to each of the recipient entities 110.

The originating entity 105 sends 112, 114, 116 the message to each of the recipient entities 110. Particularly, the message that is received by the recipient entities 110 is the same message that is sent by the originating entity 105, without any modification of content associated with the message. As shown in FIG. 1, the originating entity 105 receives 118, 120, 122 various responses from each of the recipient entities 110. For example, the responses can be direct responses to the message sent to the recipient entities 110.

However, there are drawbacks to the existing communication pattern 100 as detailed in FIG. 1. Particularly, the originating entity 105 receives all of the various responses from each of the recipient entities 110 even though, in some cases, the originating entity 105 may not desire to receive all of the responses, may have to examine each the responses to locate a desired response, and/or may not receive a desired response at all. In some other cases, the originating entity 105 may not want to receive a response until a certain criteria is met. In these cases, the originating entity 105 may have to initiate a further round of messaging with the recipient entities 110 until the criteria is met.

Accordingly, there is an opportunity to accumulate the return messages before sending them to the originating entity 105. Particularly, there is an opportunity to receive return messages and generate a single accumulated message that includes indications of some or all of the return messages. Further, the single accumulated message can be generated in response to a predefined criteria being met and/or in association with an initiation of an application. In embodiments, a further message can optionally be sent to the recipient entities 110 until the predefined criteria is met.

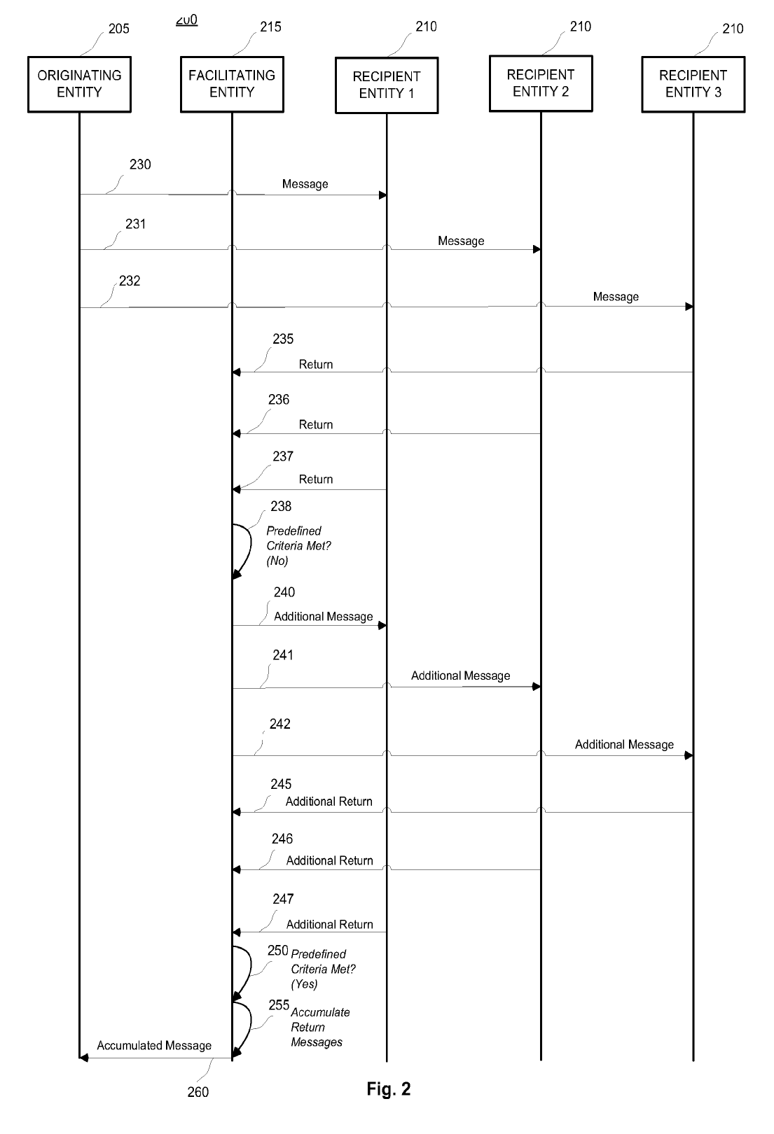

Referring to FIG. 2, depicted is a communication pattern 200 detailing the present Embodiments. Similar to the communication pattern 100 of FIG. 1, the communication pattern 200 includes an originating entity 205 and three (3) recipient entities 210. The communication pattern 200 further includes a facilitating entity 215 capable of facilitating messages between and among the originating entity 205 and the recipient entities 210. It should be understood that the facilitating entity 215 can include any combination of hardware and software capable of performing the functionalities as discussed herein. For example, the facilitating entity 215 can be any type of computer, server, or the like. Further, it should be understood that a user can interlace with the facilitating entity 215 to provide input for any of the functionalities as discussed herein.

As shown in FIG. 2, the originating entity 205 can send (230, 231, 232) a message to each of the recipient entities 210. In embodiments, the message can be any type of data capable of being communicated such as, for example, e-mails, text messages (e.g., SMS, MMS, etc), voice-to-text messages, electronic documents, or other data types. Further, the message can include content that can be any combination of metadata, body content, header information, and/or the like. Further, the message can have an associated list or information that identifies recipients to which the message is intended. For example, the list can indicate phone numbers, email addresses, or other identifying information of the intended recipients. Further still, the individual messages received by each of the recipient entities 210 can include the same or different content.

In some embodiments, the originating entity 205 can send the message to the facilitating entity 215 which can analyze the message lo determine which of the recipient entities 210 are to receive the message. Further, the facilitating entity 215 can send the message to the appropriate recipient entities 210. In embodiments, the facilitating entity 215 can perform any necessary modifications to the message before sending to the recipient entities 210.

The recipient entities 210 can receive the message and determine if and how to respond to the message. Each of the recipient entities 210 can compose and send (235, 236, 237) return messages to the facilitating entity 215. For example, if the message includes a question, the return messages can include answers or responses to the question. In one embodiment, the return message can include the original message that the originating entity 205 sent to the recipient entities 210. In some embodiments, one or more of the recipient entities 210 may not send a return message. For example, one of the recipient entities 210 may not access the message or may not choose to respond to the message, among other situations.

Upon receiving one or more of the return messages, the facilitating entity 215 can determine 238 if a predefined criteria is met. In embodiments, the predefined criteria can be based on one or more factors relating to the return messages or to the communication in general, In one embodiment, the predefined criteria can be an amount of time allotted for return messages from the recipient entities 210 to be received. The amount of time can be a fixed amount of time or can be formulaically determined based on various factors. In other embodiments, the predefined criteria can be based on an amount or percentage of the recipient entities 210 who respond or send return messages. For instance, the predefined criteria can be met if the facilitating entity 215 receives return message from at least 50% of the recipient entities 210. For further instance, the predefined criteria can be met if the facilitating entity 215 receives a single return message, receives multiple return messages, receives a return message with certain content, or receives one or more return messages from one or more specific recipient entities. In other embodiments, the predefined criteria can be met if, after analyzing the content of the received return message(s), the facilitating entity 215 determines that the return message(s) is sufficient to report to the originating entity 205. It should be appreciated that other predefined criteria are envisioned.

In embodiments, if the predefined criteria is not met, the facilitating entity 215 can send (240, 241, 242) an additional message to the recipient entities 21. In some cases, the facilitating entity 215 can send the additional message to one or more of the recipient entities 210. In some cases, the facilitating entity 215 can send the additional message to only the recipient entities 210 who did not send an initial return message to the facilitating entity 215. In embodiments, the facilitating entity 215 can modify any content of the message or any content of the return messages to generate the additional message. For example, if the original message includes a question, and recipient entity 1 did not respond to the question, then the additional message can include a reminder that recipient entity 1 has not sent a return message.

Referring to FIG. 2, the recipient entities 210 can send (245, 246, 247) additional return messages to the facilitating entity 215. In embodiments, the additional return messages can include additional content not included in the original return messages. For example, the additional return messages can include additional answers to additional questions included in the additional message. In some cases, one or more of the recipient entities 210 may not send an additional return message. For example, one of the recipient entities 210 may not access the additional message or may not choose to respond to the additional message, among other situations.

After receiving the additional return messages, the facilitating entity determines 250 if the predefined criteria is met. In embodiments, the predefined criteria of the determination 250 can be the same or different from the predetermined criteria of the determination 238. For example, the predetermined criteria can be met if one or more of the additional return messages, when added to the original return message, causes the total number of return messages to exceed a certain amount. It should be appreciated that other predefined criteria are envisioned.

According to embodiments, the facilitating entity 215 can accumulate 255 the return messages to generate an accumulated message and send 260 the accumulated message to the originating entity 205. More particularly, the accumulated message can be a single message that includes or indicates one or more of the return messages. In this regard, instead of the originating entity 205 receiving multiple return messages from multiple of the recipient entities 210, the originating entity 205 receives the single accumulated message, tints reducing the amount of messages that 1) the facilitating entity 215 sends to the originating entity 205 and 2) the originating entity 205 receives. Accordingly, the amount of necessary communication bandwidth is reduced. Further, originating entity 205 can examine the single accumulated message for any desired information, versus having to examine each of the individual return messages that are received at various points in time.

In some embodiments, the facilitating entity 215 generates the accumulated message by including a chart, graph, or other type of indication that distinguishes the various return messages received by the facilitating entity 215. For example, if the original message includes a query for the recipient entities 210 to select one or more of a set of enumerated options, and the return messages indicate the option selections by the recipient entities 210, then the accumulated message can include indications or identifications of ail of the option selections. For further example, if the original message includes a request for bids, then the accumulated message can order any bids received from the recipient entities 210. In some embodiments, the originating entity 205 can initiate a further conversation round with the recipient entitles 210. For example, the originating entity 205 may need additional information or may need to communicate an additional message or query, among other situations.

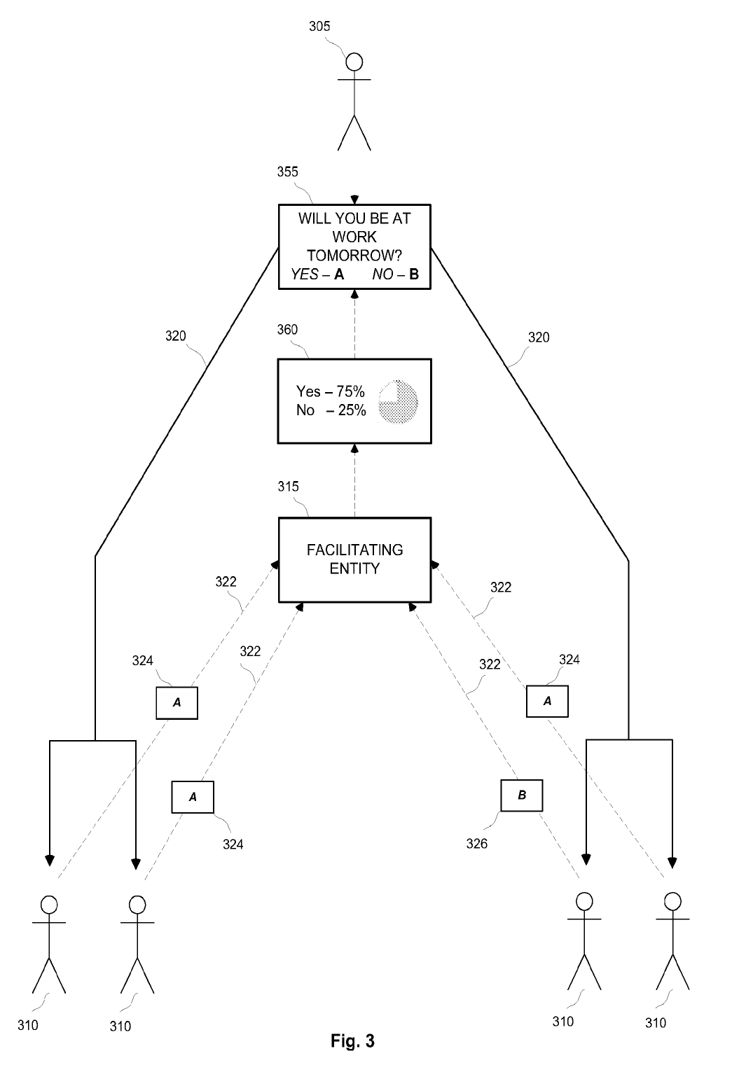

Referring to FIG. 3, depicted is an exemplary application of the functionalities as described herein. In particular, FIG. 3 depicts a situation where a message from an originating entity 305 elicits responses from a plurality of recipient entities 310, and a facilitating entity 315 accumulates the responses into an accumulated message.

As shown in FIG. 3, the originating entity 305 can create or compose a message 355 to be sent to the plurality of recipient entities 310. The message 355 can include a message body that can be in the form of a question or a query (as shown: “Will you be at work tomorrow?”). Further, the message 355 can include option selections (as shown: “Yes-A, No-B”) from which the recipient entities 310 can use to respond to the query. Particularly, the message 355 is composed such that if a given recipient entity 310 is not planning on working tomorrow, then that entity should select B; and if the given recipient entity 310 is planning on working tomorrow, then that entity should select A.

In embodiments, die originating entity 305 can specify the recipient entities 310 to which to send the message 355, and can send (320) the message 355 directly to the recipient entities 310, as illustrated in FIG. 3, In some embodiments, the originating entity 305 can send the message 355 to the recipient entities 310 via the facilitating entity 315, Upon receipt of the message 355, one or more of the recipient entities 310 can respond to the message by sending return messages. In embodiments, the recipient entities 310 can send return messages via a communication protocol whereby the return messages are routed or otherwise sent to die facilitating entity 315,

As shown in FIG. 3, the recipient entities 310 can send (322) return messages to the facilitating entity 315, Particularly, three (3) of the recipient entities 310 can each send return messages 324 (“A”) indicating that each of the three (3) recipient entities 310 will be attending work tomorrow, Further, one (1) of the recipient entities 310 can send a return message 326 (“B”) indicating that the one (1) recipient entity will not be attending work tomorrow. It should be appreciated that the return messages 324, 326 are merely exemplary and can comprise other content, Further, it should be appreciated that not all of the recipient entities 310 need to respond to the original message 355.

According to embodiments, the facilitating entity 315 can receive the return messages 324, 326 and accumulate the return messages 324, 326 into a single accumulated message. Particularly, the accumulated message can indicate all of the return messages received from the recipient entities 310. Further, the Facilitating entity 315 can format the accumulated message to depict a graphical or textual representation of the received return messages. As shown in FIG. 3, an accumulated message 360 can indicate a percentage breakdown of the various received return messages. Particularly, the accumulated message 360 can indicate that 75% of the return messages were “A-Yes” responses and 25% of the return messages were “B-No” responses. Additionally, the facilitating entity can insert a pie chart (or similar graphical representation) that indicates a breakdown of the return messages. It should be appreciated that additional and/or alternative representations, indications, and/or the like are envisioned. As shown in FIG. 3, the facilitating entity 315 can send the accumulated message 360 to the originating entity 305, who can examine the accumulated message 360 to identify any needed information.

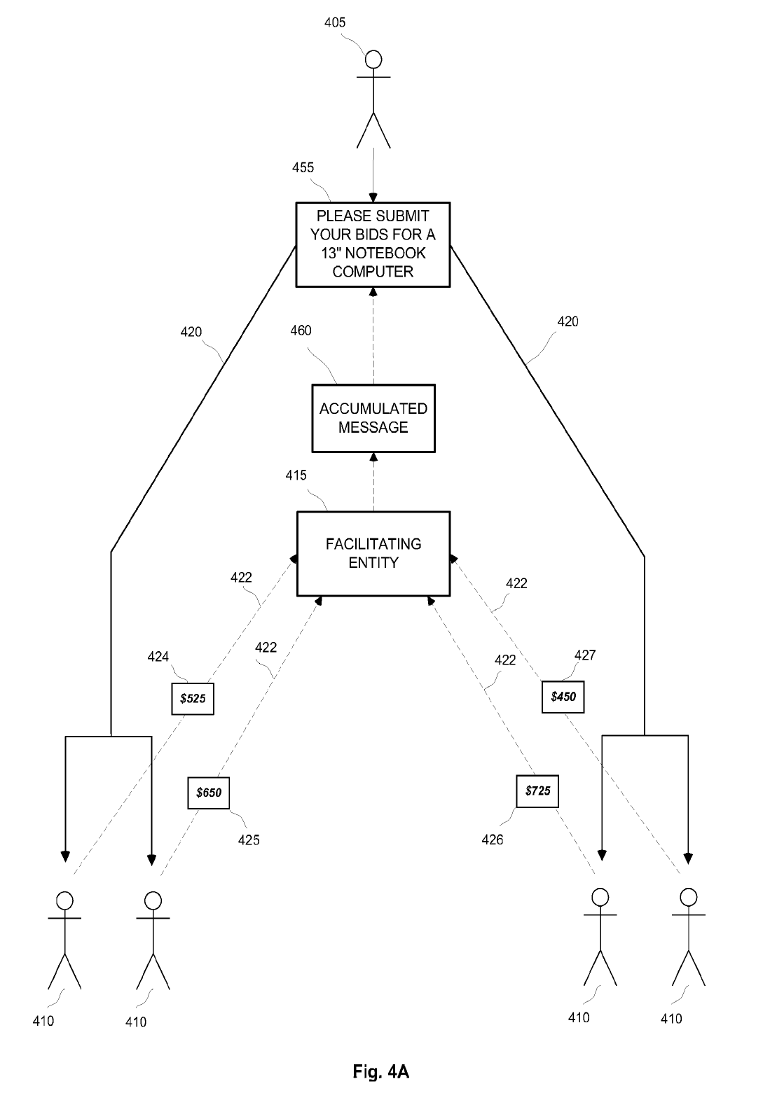

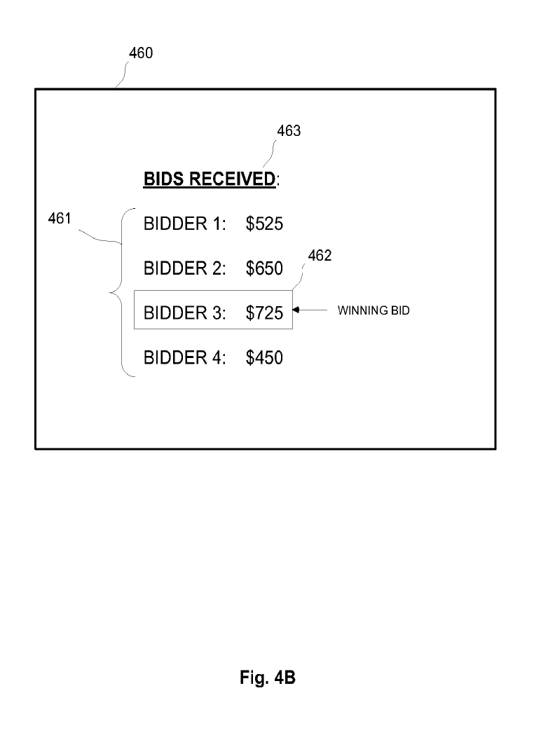

Referring to FIG. 4A, depicted is an additional exemplary application of the functionalities as described herein. In particular, FIG. 4A depicts a situation where a message from an originating entity 405 elicits responses from a plurality of recipient entities 410, and a facilitating entity 415 accumulates the responses into an accumulated message.

As shown in FIG. 4A, the originating entity 405 can create or compose a message 455 to be sent to the plurality of recipient entities 410. In embodiments as shown in FIG. 4A, the message 455 includes a message body that elicits bids for a product from the plurality of recipient entities 410 (as shown: “Please submit your bids for a 13″ notebook computer”). Particularly, the originating entity 405 may want to receive bids from the recipient entities 410 to determine which is willing to pay the highest amount for the product.

In embodiments, the originating entity 405 can specify the recipient entitles 410 to which to send the message 455, and can send (420) the message 455 directly to the recipient entities 410, as illustrated in FIG. 4A. In some embodiments, the originating entity 405 can send the message 455 to the recipient entities 410 via the facilitating entity 415. Upon receipt of the message 455, one or more of the recipient entities 410 can respond to the message by sending return messages. In embodiments, the recipient entities 410 can send return messages via a communication protocol whereby the return messages are routed or otherwise sent to the facilitating entity 415.

As shown in FIG. 4A, the recipient entities 410 can send (422) return messages 424, 425, 426, 427 to the facilitating entity 415. Particularly, the return messages 424, 425, 426, 427 indicate bids for the product identified in the message 455 (as shown: message 424 is a bid for $525, message 425 is a bid for $650, message 426 is a bid for $725, and message 427 is a bid for $450). Upon receiving one or more of the return messages 424, 425, 426, 427, the facilitating entity 415 can determine if a predefined criteria is met. For example, the predefined criteria can be met if one or more of the bids in any received return message meets or exceeds a threshold amount. If the predefined criteria is not met, the facilitating entity 415 can await the receipt of more return message. In some embodiments, for example if the predefined criteria is not met, the facilitating entity 415 can communicate with the recipient entities 410. For example, the facilitating entity 415 can send reminders to the recipient entities 410 to provide their bids.

According to embodiments, the facilitating entity 415 can receive the return messages 424, 425, 426, 427 and can generate an accumulated message 460 based on the return messages 424, 425, 426, 427. Particularly, the accumulated message 460 can serve as a summary of the return messages 424, 425, 426, 427 and can include some or all of the content of the return messages 424, 425, 426, 427. FIG. 4B depicts an exemplary accumulated message 460. It should be appreciated that the content and layout of the accumulated message 460 as depicted in FIG. 4B are merely exemplary and others are envisioned. In some embodiments, the facilitating entity 415 can automatically generate or insert the content and layout of the accumulated message 460. In other embodiments, a user can input or select some or all of the content and layout of the accumulated message 460.

The accumulated message 460 can include a summary indication 463 that indicates content of the accumulated message 460 (as shown: “BIDS RECEIVED:”). The accumulated message 460 can further include a listing 461 of the bids received from the recipient entities 410. As shown in FIG. 4B, the listing 461 includes identifications of the bidders (i.e., the recipient entities 410) as well as the amounts of the bids. Further, the accumulated message 460 can include an indication 462 of a winning bid. As shown in FIG. 4B, the winning bid is the highest bid received from the recipient entities 410 and the indication 462 highlights the winning bid.

Referring back to FIG. 4A, the facilitating entity 415 can send the accumulated message 460 to the originating entity 405. Upon receipt of the accumulated message 460, the originating entity 405 can examine the accumulated message 460 and perform any follow-up communications or other functionalities to complete or finalize the transaction or communication exchange. In some embodiments, the originating entity 405 can re-send the message 455 or a modified version of the message 455 to the recipient entities 410 and/or to additional recipient entities.

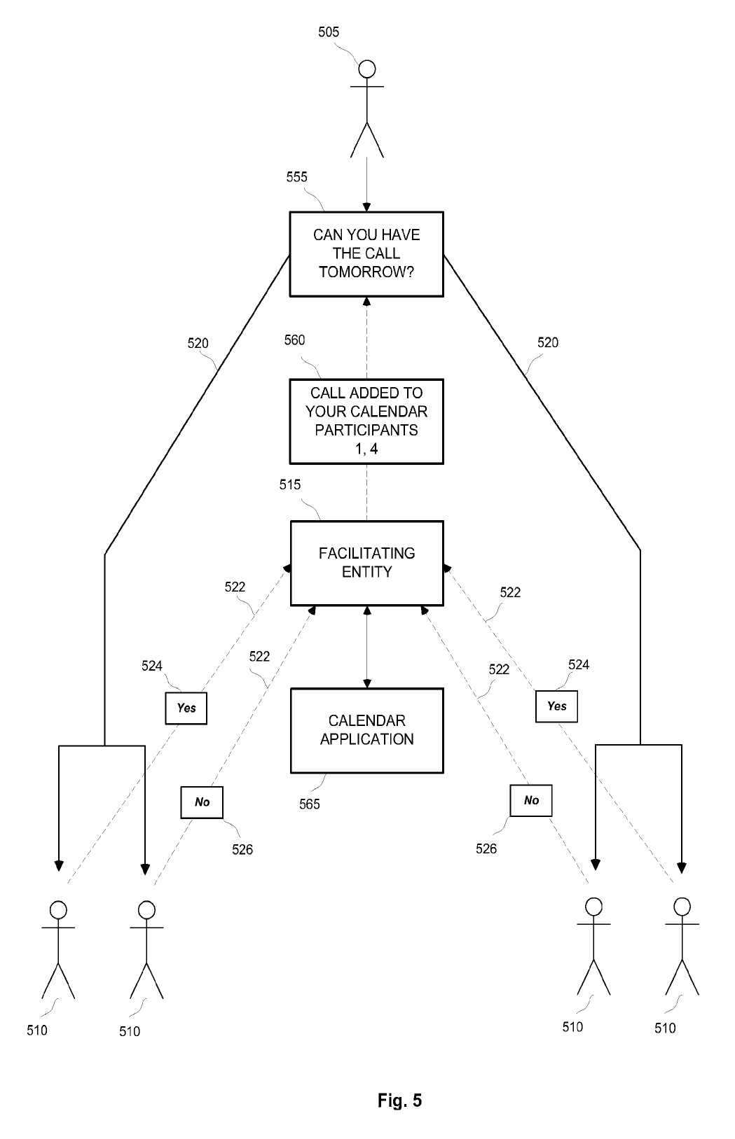

Referring to FIG. 5, depicted is an exemplary application of the functionalities as described herein. In particular, FIG. 5 depicts a situation where a message from an originating entity 505 elicits responses from a plurality of recipient entities 510, and a facilitating entity 515 initiates an application based on the responses and accumulates the responses into an accumulated message.

As shown in FIG. 5, the depicted is an exemplary application of the functionalities be sent to the plurality of recipient entities 510. The message 555 can include a message body that can be in the form of a question or a query (as shown: “Can you make the call tomorrow?”). In embodiments, the originating entity 505 can specify the recipient entities 510 to which to send the message 555, and can send (520) the message 555 directly to the recipient entities 510, as illustrated in FIG. 5. In some embodiments, the originating entity 505 can send the message 555 to the recipient entities 510 via the facilitating entity 515. Upon receipt of the message 555, one or more of the recipient entities 510 can respond to the message by sending return messages. In embodiments, the recipient entities 510 can send return messages via a communication protocol whereby the return messages are routed or otherwise sent to the facilitating entity 515.

As shown in FIG. 5, the recipient entities 510 can send (522) return messages to the facilitating entity 515. Particularly, two (2) of the recipient entities 510 can each send return messages 524 (“YES”) indicating that each of the two (2) recipient entities 510 can make the call tomorrow. Further, the remaining two (2) of the recipient entities 510 can send a return message 526 (“No”) indicating that the two (2) remaining recipient entities cannot make the call tomorrow. It should be appreciated that the return messages 524, 526 are merely exemplary and can comprise other content. Further, it should be appreciated that it is not necessary for all of the recipient entities 510 to respond to the original message 555.

According to embodiments, the facilitating entity 515 can receive the return messages 524, 526 and analyze the return messages 524, 526 to determine if an application needs to be initiated or an external system accessed. In some embodiments, the facilitating entity 515 can analyze the return messages 524, 526 to determine if an internal or external interface needs to be initiated. For example, as shown in FIG. 5, the application can be a calendar application 565. Particularly, the facilitating entity 515 can initiate the calendar application 565 to create an appointment to send to the originating entity 505 to place or put the call referenced in the message 555 on the originating entity's calendar. According to embodiments, the application can be internal or external.

After initiating the calendar application 565, the facilitating entity 515 can generate an accumulated message 560. As shown in FIG. 5, the accumulated message 560 can include content such as, for example, “CALL ADDED TO YOUR CALENDAR” and “PARTICIPANTS: 1,4.” Further, as indicated in FIG. 5, the facilitating entity 515 can add the call to the calendars of one or more of the originating entity 505 and of the recipient entities 510 who responded that they can make the call.

As shown in FIG. 5, the facilitating entity 515 can send the accumulated message 560 to the originating entity 505. By sending the accumulated message 560 to the originating entity 505 (where the accumulated message 560 can include indications of the responses 545, 526 received from the recipient entities 510), the originating entity 505 will not receive individual responses from the recipient entitles 510. Instead, the originating entity 505 can examine the accumulated message 560 to gauge how each of the recipient entities 510 responded to the original message 555. Additionally, the facilitating entity 515 can leverage the calendar application 565 to further add additional information to the accumulated message 560 and/or facilitate applications associated with the message 555 and/or any of the entities.

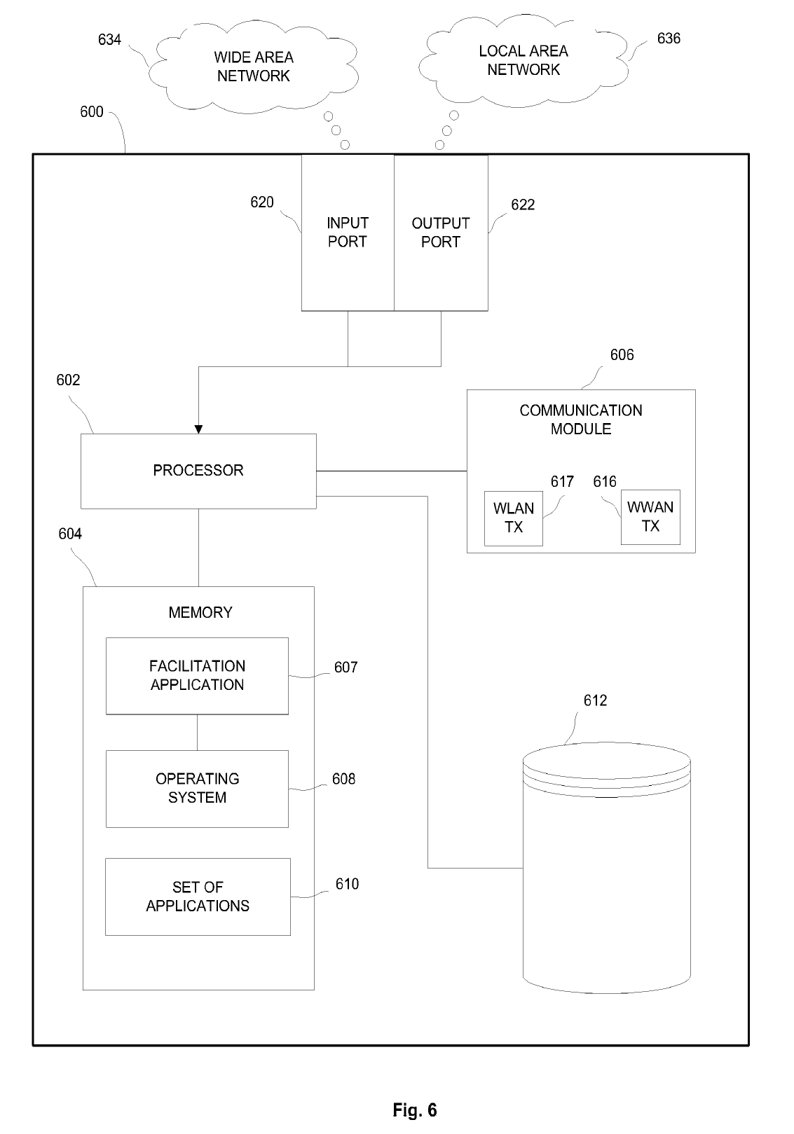

Referring to FIG. 6, depicted is an exemplary server 600 and components thereof. More particularly, the server 600 can be a combination of hardware and software components associated with the facilitating entity as discussed herein. It should be appreciated that FIG. 6 represents a generalized schematic illustration and that other hardware and software components can be added or existing components can be removed or modified.

As shown in FIG. 6, the server 600 can comprise a set of ports that can receive input signals or data from, or output signals or data to, other components of a communication environment, such as the originating entity 205 and the recipient entities 210 as discussed with respect to FIG. 2. More particularly, an input port 620 can receive cellular or other types of data from a wide area network 634 (such as various private or public networks) or a local area network 636 (such as a wireless local area network (WLAN)), and an output port 622 can output data to the wide area network 634 or the local area network 636. Although not shown in FIG. 6. the systems and methods envision other types of wired or wireless networks through which data can be communicated.

The server 600 can further comprise a processor(s) 602 communicating with a memory 604, such as electronic random access memory (RAM), or other forms of transitory or non-transitory computer readable storage mediums, operating under control of or in conjunction with an operating system 608. The operating system 608 can be any commercial, open-source, or proprietary operating system or platform. The processor 602 can communicate with a database 612, such as a database stored on a local hard drive. While illustrated as a local database in the server 600, the database 612 can be separate from the server 600.

The processor 602 can further communicate with a communication module 606, such as a wired or wireless data connection, which in turn communicates with the wide area network 634 and the local area network 636. In particular, the communication module 606 can comprise a WWAN transceiver 616 capable of communicating with the wide area network 634 and a WLAN transceiver 617 capable of communicating with the local area network 636. The set of ports 620, 622 of the server 600 can use the components of the communication module 606 to connect to any of the entities as discussed herein. For example, the input port 620 can receive a message from the originating entity 205 via the WWAN transceiver 616, and the output port 622 can send the message to the recipient entities 610 via the WWAN transceiver 616. The processor 602 can also communicate with a set of applications 610 that can be configured to execute control logic and perform data processing to perform the functions and techniques as discussed herein. For example, the set of applications 610 can comprise a facilitation application 607 that can support the functionalities of the message facilitation, as described herein. It should be appreciated that other applications 610 and functionalities thereof are envisioned.

While FIG. 6 illustrates the server 600 as a standalone system using a combination of hardware and software, the components of the server 600 can also be implemented as a software application or program capable of being executed by a conventional computer platform. Likewise, the components of the server 600 can also be implemented as a software module or program module capable of being incorporated in other software applications and programs. In either case, the components of the server 600 can be implemented in any type of conventional proprietary or open-source computer language.

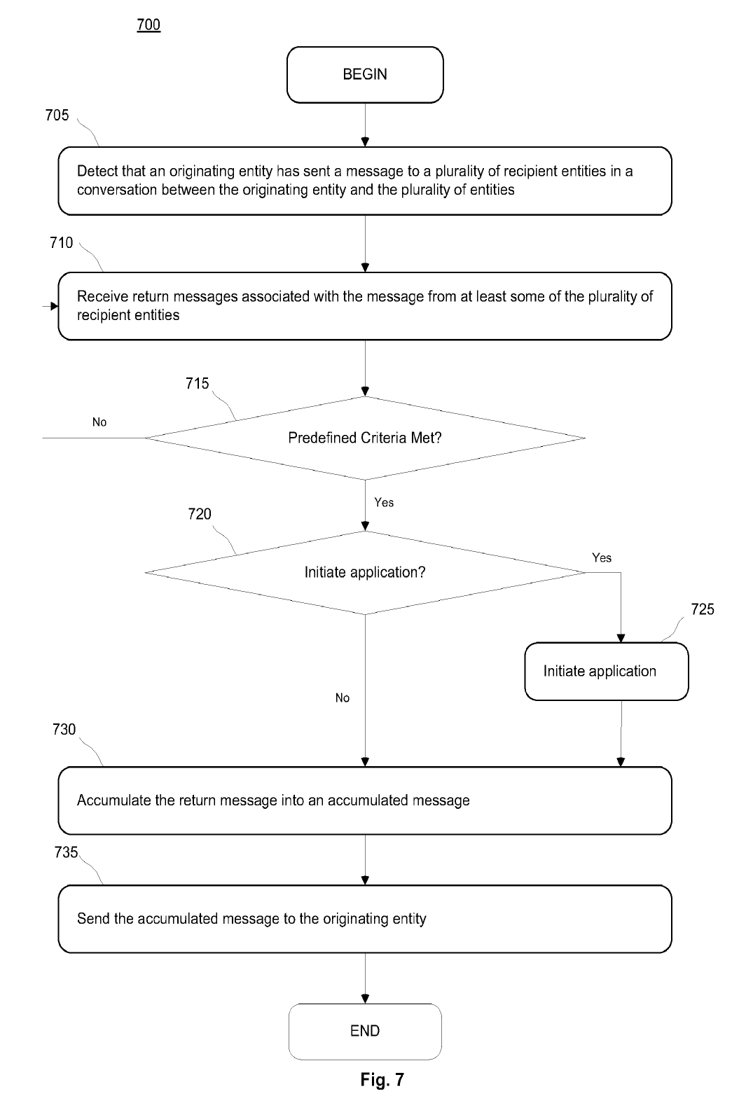

FIG. 7 is a flowchart of a method 700 for a facilitating entity (such as the facilitating entity 215 as discussed with respect to FIG. 2) to facilitate the accumulation of return messages into an accumulated message. More particularly, the method 700 relates to the facilitating entity receiving return messages from recipient entities and generating an accumulated message from the return messages.

The method 700 begins with the facilitating entity detecting 705 that an originating entity has sent a message to a plurality of recipient entities in a conversation between the originating entity and the plurality of recipient entities. In some embodiments, the facilitating entity can receive the message from the originating entity and send the message to the plurality of recipient entities. The facilitating entity receives 710 return messages associated with the message from at least some of the plurality of recipient entities. In response to receiving the return message, the facilitating entity determines 715 if a predefined criteria has been met. For example, the predefined criteria can be met if the facilitating entity receives a certain amount or percentage of return messages. If the predefined criteria is not met (“NO”), then processing can optionally proceed back to 710 where the facilitating entity can receive additional return messages.

In contrast, if the predefined criteria is met (“YES”), the facilitating entity optionally determines 720 whether to initiate an application. For example, the application can be any type of software application that can be used to modify or accumulate the return messages, or perform other functionalities related to the conversation or communication. If the facilitating entity determines to initiate the application (“YES”), the facilitating entity initiates 725 the application, If the facilitating entity determines to not initiate the application (“NO”), the facilitating entity accumulates 730 the return message into an accumulated message. In embodiments, the accumulated message can include some or all of the content of the received return messages. The facilitating entity sends 735 the accumulated message to the originating entity. In embodiments, the facilitating entity sends the accumulated message via any type of communication protocol.

Thus, it should be clear from the preceding disclosure that the system and method effectively and efficiently manages a message exchange between an originating entity and a plurality of recipient entities. The system and method advantageously allows a facilitating entity to accumulate a plurality of received return messages of a conversation into a single message, and send the single message to an entity who originated the conversation. Further, the system and method reduces the amount of communication among the entities of the conversation.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiments(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1. A method of managing messaging within a conversation between an originating entity and a plurality of recipient entities, the method comprising:
detecting, by a first computer, that the originating entity has sent a message to the plurality of recipient entities;
receiving, at the first computer, return messages associated with the message from at least some of the plurality of recipient entities:
determining, by the first computer, that a predefined criteria associated with the return messages has been met;
in response to the determining, accumulating the return messages into an accumulated message; and
sending the accumulated message to the originating entity.

2. The method of claim 1, wherein the message relates to a query with enumerated options and the return messages relate to responses to the enumerated options, and wherein accumulating the return messages into the accumulated message comprises:
identifying one or more selection counts associated with the responses from the at least some of the plurality of recipients; and
generating the accumulated message by compiling the one or more selection counts associated with the responses.

3. The method of claim 1, wherein in response to the determining, the method further comprises;
initiating an internal or external application or communicating to an internal or external interlace, wherein the accumulated message indicates the application of the interface.

4. The method of claim 1, wherein determining that the predefined criteria associated with the return messages has been met comprises:
identifying, from the predefined criteria, an internal or external application or an internal or external interface to be initiated; and
initiating the application or the interface.

5. The method of claim 1, wherein determining that the predefined criteria associated with the return messages has been met comprises:
determining that the predefined criteria has not been met;
in response to determining that the predefined criteria not been met:
sending the message to the plurality of recipient entities, and
receiving at least one additional return message associated with the message from at least one of the plurality of recipient entities; and
repeating the determining, the sending, and the receiving until the predefined criteria has been met.

6. The method of claim 1, wherein the predefined criteria is one or more of a predetermined amount of time, a predetermined selection count or percentage associated with the return messages, or an algorithmic determination.

7. The method of claim 1, wherein the message comprises a bid requirement and the return messages comprise bids from the at least some of the plurality of recipient entities, and wherein accumulating the return messages into an accumulated message comprises:
identifying a winning bid from the bids received from the at least some of the plurality of recipient entities; and
generating the accumulated message to indicate the winning bid.

8. The method of claim 7, wherein identifying the winning bid comprises:
examining the bids received from the at least some of the plurality of recipient entities to determine that none of the bids fulfill the bid requirement;
in response to examining the bids:
sending the bid requirement to the plurality of recipient entities, and
receiving at least one additional bid from at least one of the plurality of recipient entities; and
repeating the examining, the sending, and the receiving until the bid requirement has been fulfilled.

9. A system for managing a conversation between an originating entity and a plurality of recipient entities, the system comprising:
a server comprising a communication module for sending and receiving messages associated with the conversation; and
a processor coupled to the server and configured to perform operations comprising:
detecting that the originating entity has sent a message to the plurality of recipient Entities;
receiving return messages associated with the message from at least some of the plurality of recipient entitles;
determining that a predefined criteria associated with the return messages has been me;
in response to the determining, accumulating the return messages into an accumulated message; and
sending the accumulated message to the originating entity.

10. The system of claim 9, wherein the message relates to a query with enumerated options and the return messages relate to responses to the enumerated options, and wherein accumulating the return messages into the accumulated message comprises:
identifying one or more selection counts associated with the responses from the at least some of the plurality of recipients; and
generating the accumulated message by compiling the one or more selection counts associated with the responses.

11. The system of claim 9, wherein in response to the determining, the processor is further configured to perform operations comprising:
initiating an application or communicating to an interface, wherein the accumulated message indicates the application or the interlace.

12. The system of claim 9, wherein determining that the predefined criteria associated with the return messages has been met comprises:
identifying, from the predefined criteria, an application or an interface to be initiated; and
initiating the application or the interface.

13. The system of claim 9, wherein determining that the predefined criteria associated with the return messages has been met comprises:
determining that the predefined criteria has not been met;
in response to determining that the predefined criteria has not been met:
sending the message to the plurality of recipient entities, and
receiving at least one additional return message associated with the message from at least one of the plurality of recipient entities; and
repeating the determining, the sending, and the receiving until the predefined criteria has been met.

14. The system of claim 9, wherein the predefined criteria is one or more of a predetermined amount of time, a predetermined selection count or percentage associated with the return messages, or an algorithmic determination.

15. A non-transitory computer readable medium comprising computer instructions embodied thereon to:
cause a processor to detect that the originating entity has sent a message to the plurality of recipient entities;
cause the processor to receive return messages associated with the message from at least some of the plurality of recipient entities;
cause the processor to determine that a predefined criteria associated with the return messages has been met;
in response to the determining, cause the processor to accumulate the return messages into an accumulated message; and
cause the processor to send the accumulated message to the originating entity.

16. The non-transitory computer readable medium of claim 15, wherein the message relates to a query with enumerated options and the return messages relate to responses to the enumerated options, and wherein accumulating the return messages into the accumulated message comprises:
identifying one or more selection counts associated with the responses from the at least some of the plurality of recipients; and
generating the accumulated message by compiling the one or more selection counts associated with the responses.

17. The non-transitory computer readable medium of claim 15, wherein in response to the determining, die computer instructions further cause the processor to initiate an application, wherein the accumulated message indicates the application.

18. The non-transitory computer readable medium of claim 15. wherein determining that the predefined criteria associated with the return messages has been met comprises:
identifying, from the predefined criteria, an application or an interface to be initiated; and
initiating the application or the interface.

19. The non-transitory computer readable medium of claim 15, wherein the message comprises a bid requirement and the return messages comprise bids from the at least some of the plurality of recipient entities, and wherein accumulating the return messages into an accumulated message comprises:
identifying a winning bid from the bids received from the at least some of the plurality of recipient entities; and
generating the accumulated message to indicate the winning bid.

20. The non-transitory computer readable medium of claim 19, wherein identifying the winning bid comprises:
examining the bids received from the at least some of the plurality of recipient entities to determine that none of the bids fulfill the bid requirement;
in response to examining the bids:
sending the bid requirement to the plurality of recipient entities, and
receiving at least one additional bid from at least one of the plurality of recipient entities; and
repeating the examining, the sending, and the receiving until the bid requirement has been fulfilled.
